(19) United States
(12) Patent Application Publication
(10) Pub. No.: US 2026/0316124 A1
(43) Pub. Date: Oct. 15, 2026

(54) CLEANING SYSTEM

(71) Applicant: FUJI ELECTRIC CO., LTD., Kanagawa (JP)

(72) Inventors: Hirono OKANO, Tokyo (JP); Azusa OZAWA, Tokyo (JP); Shinya UI, Tokyo (JP)

(21) Appl. No.: 19/687,777

(22) Filed: May 26, 2026

Related U.S. Application Data
(63) Continuation of application No. PCT/JP2025/017428, filed on May 13, 2025.

(30) Foreign Application Priority Data
Jun. 20, 2024 (JP) 2024-099623

(51) Int. Cl. B08B 3/08; F24T 10/00

(52) U.S. Cl. CPC B08B 3/08; F24T 2010/50

(57) ABSTRACT

A cleaning system is provided and includes a chemical liquid supply pipe connectable to one end on an upstream side of a cleaning target portion, and including a chemical agent inlet port; a chemical agent injector; a first pipe connecting the chemical agent inlet port and the chemical agent injector, and including a chemical agent recovery port; a return pipe connecting another end on a downstream side of the cleaning target portion and the chemical agent recovery port; a circulation pump configured to circulate a chemical agent; an analyzer connected to a branch pipe branched from the first pipe, and configured to analyze change over time in components of waste liquid sent to the branch pipe; and control circuitry.

### CROSS-REFERENCE TO RELATED APPLICATIONS

This application is a continuation application of International Application No. PCT/JP 2025/017428, filed on May 13, 2025, and designated the U.S., which is based upon and claims priority to Japanese Patent Application No. 2024-099623, filed on Jun. 20, 2024, the entire contents of which are incorporated herein by reference.

### BACKGROUND

### 1. Field of the Invention

The present disclosure relates to a cleaning system.

### 2. Description of the Related Art

Geothermal power generation plants extract high-temperature geothermal fluid (geothermal brine and geothermal steam) from a production well, and generate power by using geothermal brine or geothermal steam separated from the geothermal fluid. The geothermal fluid extracted from the production well contains more calcium, dissolved silica, and the like than well water and river water.

Calcium or dissolved silica in geothermal brine extracted from the production well becomes concentrated due to decompression in the geothermal power generation plants, and cools as it flows through piping, resulting in decreased solubility. Then, when the calcium, the dissolved silica, or the like contained in the geothermal brine become supersaturated, they polymerize into calcium carbonate, amorphous silica, etc., and precipitate as scale.

Adhesion of the scale inside the pipe is an issue in the geothermal power generation plants, because the scale adhering to an inner wall or the like of the pipe may cause, for example, blockage of the pipe.

In view of this, studies are being conducted to prevent or remove scaling in geothermal power generation plants. For example, in the geothermal power generation system described in Japanese Laid-Open Patent Application No. 2015-90147, hydrogen peroxide water is supplied as an oxidizing agent to separated geothermal brine on a downstream side of a gas-liquid separator, thereby preventing scale adhesion of silica components in a geothermal brine system.

### SUMMARY

An aspect of the present disclosure provides a cleaning system configured to remove scale adhering to a cleaning target portion in a geothermal power generation plant including a gas-liquid separator configured to separate geothermal brine and geothermal steam from geothermal fluid emitted from a production well, and the cleaning target portion provided on a downstream side of the gas-liquid separator. The cleaning system includes: a chemical liquid supply pipe that is connectable to one end on an upstream side of the cleaning target portion, and includes a chemical agent inlet port; a chemical agent injector that is configured to inject a chemical agent into the chemical agent inlet port; a first pipe that connects the chemical agent inlet and the chemical agent injector, and includes a chemical agent recovery port; a return pipe that connects another end on a downstream side of the cleaning target portion and the chemical agent recovery port; a circulation pump that is provided partway along the first pipe between the chemical agent inlet and the chemical agent recovery port, and is configured to circulate the chemical agent; an analyzer that is connected to a branch pipe branched from the first pipe, and is configured to analyze change over time in components of waste liquid sent to the branch pipe; and control circuitry. The control circuitry is configured to predict an uppermost surface component of the scale based on an analysis result of the analyzer, determine one chemical agent suitable for the uppermost surface component from among at least three chemical agents, and control the chemical agent injector to supply the determined chemical agent.

### BRIEF DESCRIPTION OF THE DRAWINGS

FIG. 1 is a schematic diagram of a geothermal power generation plant according to an embodiment of the present disclosure;

FIG. 2 is a schematic diagram of a cleaning system according to an embodiment of the present disclosure;

FIG. 3 is a schematic diagram illustrating a layered structure of scale;

FIG. 4 is a diagram illustrating a flow of chemical agent switching control performed by control circuitry;

FIG. 5 is a diagram illustrating a flow of temperature control performed by the control circuitry;

FIG. 6 is a graph illustrating a relationship between a detection temperature of a thermometer and an output of a heater;

FIG. 7 is a schematic diagram for explaining reverse direction cleaning;

FIG. 8 is a diagram illustrating a flow of cleaning direction switching control performed by the control circuitry; and

FIG. 9 is a graph illustrating a relationship between an elapsed time and a scale elution rate.

### DETAILED DESCRIPTION OF THE PRESENT DISCLOSURE

However, in the geothermal power generation system described in Japanese Laid-Open Patent Application No. 2015-90147, no study was conducted on the removal of the scale adhering to and deposited on the inner wall or the like of the pipe. Further, the scale grows as the components forming the scale change in stages, thereby depositing in layers. Thus, when removing the scale adhering to and deposited on the inner wall or the like of piping by using an oxidizing agent in geothermal power generation plants, it is possible to remove scale of one component, but it is difficult to remove scale of another component, which can lead to cleaning failure.

In an aspect of the present disclosure, a cleaning system capable of sufficiently removing scale is provided.

Hereinafter, embodiments of the present disclosure will be described with reference to the drawings.

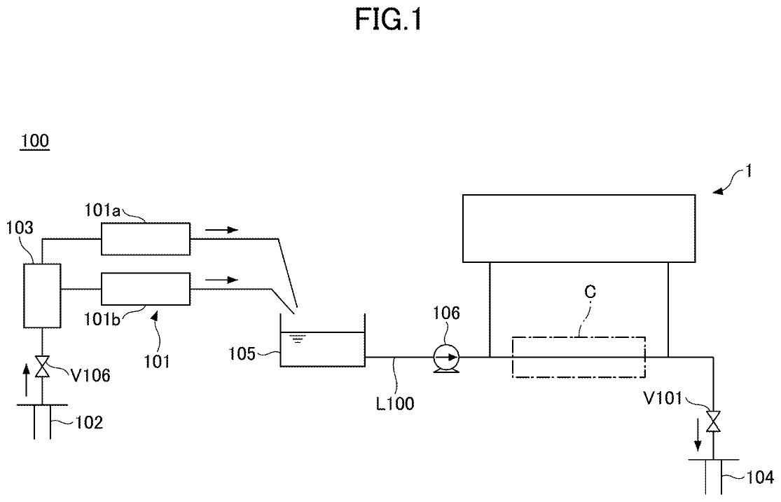

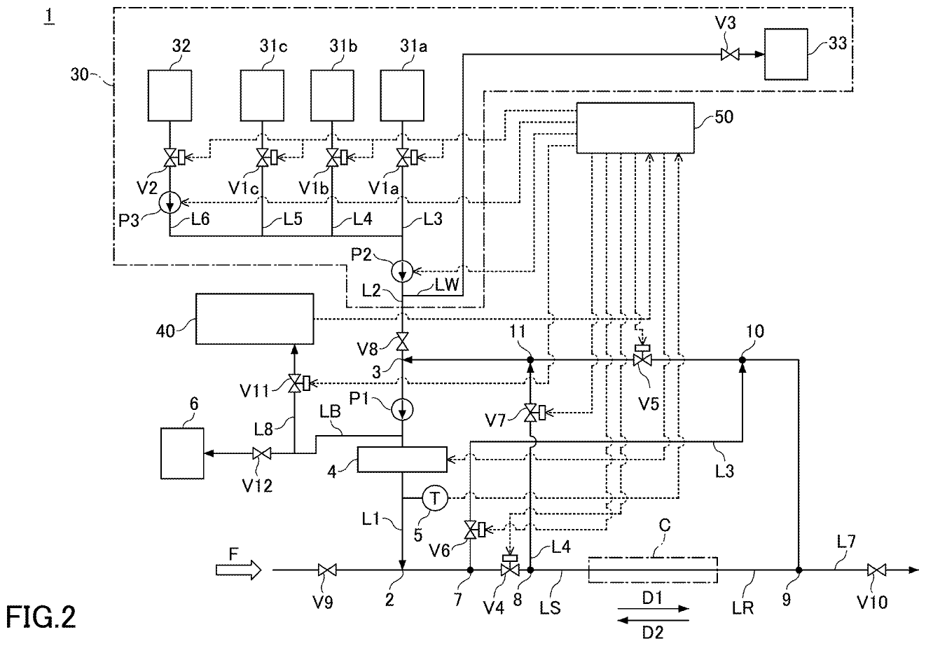

FIG. 1 is a schematic diagram of a geothermal power generation plant 100 according to an embodiment of the present disclosure. FIG. 2 is a schematic diagram of a cleaning system 1 according to an embodiment of the present disclosure. As illustrated in FIGS. 1 and 2, the cleaning system 1 removes scale adhering to a cleaning target portion C in the geothermal power generation plant 100 including a gas-liquid separator 103 configured to separate geothermal brine and geothermal steam from geothermal fluid emitted from a production well 102, and the cleaning target portion C provided on a downstream side of the gas-liquid separator 103.

An example of the geothermal power generation plant 100 in which the cleaning system 1 is to be provided will be described. The geothermal power generation plant 100 includes, for example, the gas-liquid separator 103, a power generator 101, a retention tank 105, a re-injection line L100, a re-injection pump 106, and the cleaning system 1, as illustrated in FIG. 1. In FIG. 1, arrows indicate a flow of fluid.

In the geothermal power generation plant 100, geothermal fluid extracted from the production well 102 is sent to the gas-liquid separator 103. The gas-liquid separator 103 separates the geothermal brine and the geothermal steam from the geothermal fluid emitted from the production well 102. The geothermal brine and geothermal steam separated by the gas-liquid separator 103 are sent to the power generator 101 through piping, and the power generator 101 generates power using the geothermal brine or geothermal steam, separated by the gas-liquid separator 103, as a heat source. The geothermal brine heat-recovered by the power generator 101 is introduced into the retention tank 105 through piping.

In the example illustrated in FIG. 1, the geothermal steam separated by the gas-liquid separator 103 is sent to a flash power generator 101a. The flash power generator 101a generates power using the geothermal steam, separated by the gas-liquid separator 103, as a heat source. The geothermal brine separated by the gas-liquid separator 103 is sent to a binary power generator 101b. The binary power generator 101b generates power using the geothermal brine, separated by the gas-liquid separator 103, as a heat source.

No particular limitation is imposed on the power generator 101, and the power generator 101 may include the flash power generator 101a and the binary power generator 101b. Alternatively, the power generator 101 may include either the flash power generator 101a or the binary power generator 101b.

The flash power generator 101a includes, for example: a turbine configured to rotate by supply of the geothermal steam separated by the gas-liquid separator 103; a power generator connected to the turbine; a condenser configured to condense the geothermal steam discharged from the turbine; and a cooling tower configured to cool condensed water condensed by the condenser. The binary power generator 101b includes, for example: a medium evaporator configured to perform heat exchange to evaporate a heat medium having a low boiling point; a turbine configured to rotate by supply of the vaporized heat medium; a power generator; and a medium condenser.

The retention tank 105 is configured to retain the geothermal brine heat-recovered by the power generator 101. In the retention tank 105, the polymerization reaction of silica in the geothermal brine proceeds, and the geothermal brine is retained until the silica-based insoluble components sufficiently aggregate and precipitate.

The re-injection line L100 is a line connecting the outlet port of the retention tank 105 and a re-injection well 104.

The re-injection pump 106 is provided partway along the re-injection line L100, and is configured to return the geothermal brine, discharged from the retention tank 105, to the re-injection well 104. The geothermal brine discharged from the retention tank 105 is returned to the re-injection well 104 through the re-injection line L100 by the re-injection pump 106.

The cleaning target portion C is the re-injection line L100 (pipe) in the example illustrated in FIG. 1. This is by no means a limitation. The cleaning target portion C may be any member or portion, in the geothermal power generation plant, that is contacted by the geothermal fluid, such as piping, a heat exchanger, a valve, or the like at any other location.

Next, the cleaning system 1 will be described. As illustrated in FIG. 2, the cleaning system 1 includes a chemical liquid supply pipe LS, a chemical agent injector 30, a first pipe L1, a return pipe LR, a circulation pump P1, an analyzer 40, and control circuitry 50. The cleaning system 1 may further include a heater 4 and a thermometer 5. Note that the control circuitry 50 is an example of the control circuitry included in the cleaning system of the present disclosure. The control circuitry included in the cleaning system of the present disclosure is an electronic circuit (including a processor), such as a central processing unit (CPU), a graphics processing unit (GPU), a digital signal processor (DSP), a field programmable gate array (FPGA), an application specific integrated circuit (ASIC), or the like, and is configured to execute various processes described in the present specification by executing instruction codes stored in a memory or by being designed as a circuit for specific applications.

The chemical liquid supply pipe LS is connectable to one end on the upstream side of the cleaning target portion C. The chemical liquid supply pipe LS includes a chemical agent inlet port 2. The chemical agent inlet port 2 may be provided partway along the chemical liquid supply pipe LS. The other end of the chemical liquid supply pipe LS may be connected to the re-injection line L100 of the geothermal power generation plant 100. The other end (upstream end) of the chemical liquid supply pipe LS may be connected to a portion of any geothermal power generation plant, rather than the geothermal power generation plant 100. A geothermal fluid F flows from the other end of the chemical liquid supply pipe LS.

The chemical agent injector 30 is configured to inject a chemical agent into the chemical agent inlet port 2. Specifically, the chemical agent injector 30 injects the chemical agent into the chemical agent inlet port 2 through the first pipe L1, which will be described below. The chemical agent injector 30 may include: at least three chemical agent tanks 31a, 31b, and 31c configured to store respective chemical agents; a second pipe L2 connecting the first pipe L1 and the chemical agent tanks 31a, 31b, and 31c; and a chemical agent injection pump P2 configured to discharge the chemical agents stored in the chemical agent tanks 31a, 31b, and 31c toward the chemical agent inlet port 2. The number of the chemical agent tanks 31a, 31b, and 31c is three in the example illustrated in FIG. 2. This is by no means a limitation. The number of chemical agent tanks may be four or more.

The chemical agents stored in the chemical agent tanks 31a, 31b, and 31c are chemical agents for removing and cleaning the scale adhering to the cleaning target portion C. The at least three chemical agent tanks 31a, 31b, and 31c may respectively store a first basic chemical agent; a mixed chemical agent of a second basic chemical agent, a chelating agent, and a dispersant; and an acidic chemical agent. In the present embodiment, the chemical agent tank 31a stores the first basic chemical agent, the chemical agent tank 31b stores the mixed chemical agent, and the chemical agent tank 31c stores the acidic chemical agent. These three chemical agents can be used in accordance with the components of the scale, which change during the growth process of the scale.

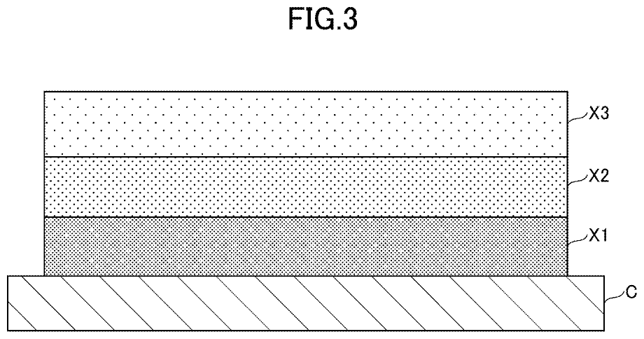

FIG. 3 is a schematic diagram illustrating a layered structure of the scale. As illustrated in FIG. 3, the scale grows as the components forming the scale change in stages, thereby depositing in layers on the cleaning target portion C, such as, for example, the inner wall of piping. As a result of analyzing the components of the layers of the scale, the present inventors consider that, when the cleaning target portion C is formed of iron, the scale is grown and deposited in the following order from the cleaning target portion C, Le., an initial layer X1 containing iron oxide as a main component, an intermediate layer X2 containing, as main components, silica and impurities (calcium, aluminum, iron, etc.), and a growth layer X3 containing amorphous silica as a main component. Also, the present inventors confirmed that the iron ion concentration decreases in the order of the initial layer X1, the intermediate layer X2, and the growth layer X3.

The first basic chemical agent can be used to dissolve the growth layer X3. Examples of the first basic chemical agent include sodium hydroxide, potassium hydroxide, ammonium salts, and the like.

The mixed chemical agent can be used to dissolve the intermediate layer X2. The second basic chemical agent included in the mixed chemical agent can be selected from chemical agents that are the same as those for the first basic chemical agent described above, and may be a chemical agent that is the same as or different from the first basic chemical agent.

Examples of the chelating agent included in the mixed chemical agent include ethylenediaminetetraacetic acid (EDTA), nitrilotriacetic acid (NTA). hydroxyethylenediaminetriacetic acid (HEDTA), diethylenetriaminepentaacetic acid (DTPA), trimethanolamine, sodium gluconate, and the like. Of these, the chelating agent is preferably EDTA, NTA, HEDTA, or DTPA.

Examples of the dispersant included in the mixed chemical agent include sodium polyacrylate, maleic acid, a diallyldimethylammonium chloride-acrylamide copolymer, and the like.

The acidic chemical agent can be used to dissolve the initial layer X1. Examples of the acidic chemical agent include sulfuric acid, hydrochloric acid, acetic acid, citric acid, and the like.

As illustrated in FIG. 2, the chemical agent injector 30 may further include: a water tank 32 disposed on an upstream side of the chemical agent tanks 31a, 31b, and 31c and configured to store water; a water feed pump P3 configured to introduce water into the second pipe L2; a water drain pipe (water drain line) LW branched from the second pipe L2 on a downstream side of the chemical agent injection pump P2; and a waste water tank 33 connected to the water drain pipe LW and configured to store water passed through the second pipe L2. Here, the upstream side or the downstream side in the chemical agent injector 30 means an upstream side or a downstream side with respect to the direction in which the chemical agent or water flows.

The water stored in the water tank 32 is water for washing away the chemical agent remaining in the second pipe L2 when changing the type of the chemical agent to be injected into the chemical agent inlet port 2 through the second pipe L2, and may be, for example, one selected from tap water, river water, and distilled water.

The chemical agent injector 30 may include: a third pipe L3 branched from the second pipe L2 and connected to the outlet port of the chemical agent tank 31a; a fourth pipe L4 branched from the second pipe L2 and connected to the outlet port of the chemical agent tank 31b; a fifth pipe L5 branched from the second pipe L2 and connected to the outlet port of the chemical agent tank 31c; and a sixth pipe L6 branched from the second pipe L2 and connected to the outlet port of the water tank 32. Also, the chemical agent injector 30 may include: a valve V1a provided partway along the third pipe L3 and configured to open and close the flow path of the third pipe L3; a valve V1b provided partway along the fourth pipe L4 and configured to open and close the flow path of the fourth pipe L4; a valve V1c provided partway along the fifth pipe L5 and configured to open and close the flow path of the fifth pipe L5; a valve V2 provided partway along the sixth pipe L6 and configured to open and close the flow path of the sixth pipe L6; and a valve V3 provided partway along the water drain pipe LW and configured to open and close the flow path of the water drain pipe LW.

The first pipe L1 connects the chemical agent inlet port 2 and the chemical agent injector 30. Specifically, the first pipe L1 connects the chemical agent inlet port 2 and the second pipe L2. The first pipe L1 includes a chemical agent recovery port 3. The chemical agent recovery port 3 may be provided partway along the first pipe L1. The other end of the chemical liquid supply pipe LS may be connected to piping of the geothermal power generation plant.

The return pipe LR connects the other end on a downstream side of the cleaning target portion C, and the chemical agent recovery port 3. The return pipe LR circulates the waste liquid passed through the cleaning target portion C, and returns the waste liquid to the first pipe L1 through the chemical agent recovery port 3. A circulation line is formed by: a portion from the chemical agent inlet port 2 of the chemical liquid supply pipe LS to one end of the cleaning target portion C; the return pipe LR; and a portion from the chemical agent recovery port 3 to the chemical agent inlet port 2 of the first pipe L1. The cleaning system 1 uses the circulation line to circulate the chemical agent in a forward direction D1 toward the cleaning target portion C.

The circulation pump P1 is provided partway along the first pipe L1 between the chemical agent inlet port 2 and the chemical agent recovery port 3, and is configured to circulate the chemical agent. Specifically, the circulation pump P1 discharges the chemical agent, supplied from the chemical agent injector 30, toward the chemical agent inlet port 2, thereby circulating the chemical agent in the circulation line.

The heater 4 is provided partway along the first pipe L1 between the circulation pump P1 and the chemical agent inlet port 2. The heater 4 is configured to heat the chemical agent supplied from the chemical agent injector 30 and flowing through the first pipe L1.

The thermometer 5 is connected to the first pipe L1 between the heater 4 and the chemical agent inlet port 2. The thermometer 5 is configured to detect the temperature of the chemical agent, supplied from the chemical agent injector 30 and flowing through the first pipe L1, and to transmit the detected data to the control circuitry 50.

The analyzer 40 is connected to a branch pipe LB branched from the first pipe L1, and is configured to analyze the change over time in the components of the waste liquid sent to the branch pipe LB. The branch pipe LB may be branched from the first pipe L1 between the circulation pump P1 and the heater 4. The analyzer 40 transmits an analysis result to the control circuitry 50. Specifically, the analyzer 40 measures the change over time in the iron ion concentration, and transmits the measurement result to the control circuitry 50. For example, a high-performance liquid chromatograph can be used as the analyzer 40.

The cleaning system 1 may include: a valve V8 provided on an upstream side of the chemical agent recovery port 3 of the first pipe L1 (on the chemical agent injector 30 side) and configured to open and close the flow path of the first pipe L1; a valve V9 provided on an upstream side of the chemical agent inlet port 2 of the chemical liquid supply pipe LS and configured to open and close the flow path of the chemical liquid supply pipe LS; a seventh pipe L7 branched from a branch portion 9 on an upstream side of a branch portion 10 of the return pipe LR (on the other end side of the cleaning target portion C); and a valve V10 provided partway along the seventh pipe L7 and configured to open and close the flow path of the seventh pipe L7.

The cleaning system 1 may include an eighth pipe L8 branched from the branch pipe LB and connected to the inlet of the analyzer 40; and a valve V11 provided partway along the eighth pipe L8 and configured to open and close the flow path of the eighth pipe L8. Also, the cleaning system 1 may include: a waste liquid tank 6 connected to the end of the branch pipe LB and configured to store waste liquid; and a valve V12 provided partway along the branch pipe LB and configured to open and close the flow path of the branch pipe LB.

The control circuitry 50 is configured to control the chemical agent injector 30, the heater 4, and the respective valves. The control circuitry 50 is configured to predict an uppermost surface component of the scale based on the analysis result of the analyzer 40, determine one chemical agent suitable for the uppermost surface component from among at least three chemical agents, and control the chemical agent injector 30 to supply the determined chemical agent.

Specifically, the control circuitry 50 predicts the uppermost surface component of the scale based on the iron ion concentration detected by the analyzer 40. Also, the three chemical agents can be: the first basic chemical agent; the mixed chemical agent of the second basic chemical agent, the chelating agent, and the dispersant; and the acidic chemical agent. The control circuitry 50 further controls the heater 4 based on the detection temperature of the thermometer 5.

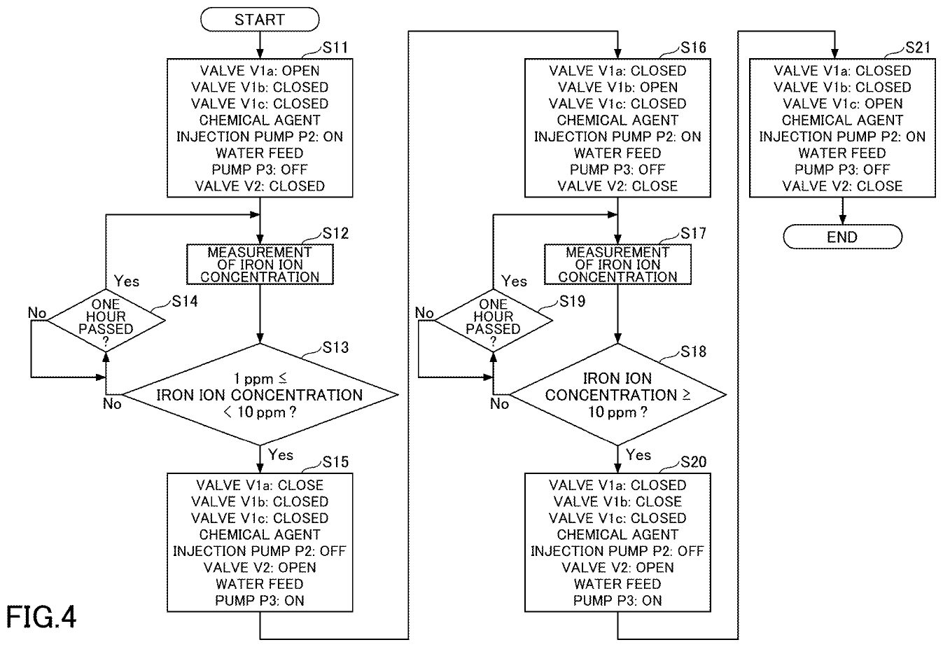

FIG. 4 is a diagram illustrating a flow of chemical agent switching control performed by the control circuitry 50. At the start of a process, it is assumed that the uppermost surface component of the scale contains amorphous silica as a main component (growth layer X3), As illustrated in FIG. 4, the control circuitry 50 opens only the valve V1a among the valves V1a, V1b, and V1c to operate the chemical agent injection pump P2 (step S11). The water feed pump P3 is in a stopped state, and the valves V1b, V1c, and V2 are in a closed state. Thus, the control circuitry 50 can inject the first basic chemical agent into the chemical agent inlet port 2 through the first pipe L1 using the chemical agent injector 30.

Next, the control circuitry 50 transmits a signal for starting the measurement of the iron ion concentration to the analyzer 40 (step S12). Then, the control circuitry 50 determines whether or not the measurement value of the iron ion concentration received from the analyzer 40 is within a set value range (step S13). In step S13, the set value of the iron ion concentration can be determined in accordance with the results obtained by previously investigating the cleaning target portion C. In step S13, the set value of the iron ion concentration can be, for example, 1 ppm or more and less than 10 ppm. When the iron ion concentration is within the set value range, the control circuitry 50 predicts that the uppermost surface component of the scale contains, as main components, silica and impurities (calcium, aluminum, iron, etc.) (intermediate layer X2).

When determining that the iron ion concentration received from the analyzer 40 is within the set value range (step S13: Yes), the control circuitry 50 closes the valve V1a, stops the chemical agent injection pump P2, opens the valve V2, and operates the water feed pump P3 (step S15). Thus, the cleaning system 1 can clean the first basic chemical agent remaining in the second pipe L2 before switching the chemical agent supplied by the chemical agent injector 30 to another chemical agent.

When determining that the iron ion concentration received from the analyzer 40 is outside the set value range (step S13: No), the control circuitry 50 causes a timer to measure the elapsed time. When determining that one hour has passed (step S14: Yes), the control circuitry 50 transmits again a signal for starting the measurement of the iron ion concentration to the analyzer 40 (step S12). Then, the control circuitry 50 proceeds to step S13, and repeatedly performs step S12, step S13, and step S14 until the control circuitry 50 determines that the iron ion concentration received from the analyzer 40 is within the set value range. The control circuitry 50 may include the timer.

After performing step S15, the control circuitry 50 opens only the valve V1b among the valves V1a, V1b, and V1c to operate the chemical agent injection pump P2 (step S16). The water feed pump P3 is in a stopped state, and the valves V1a, V1c, and V2 are in a closed state. Thus, the control circuitry 50 can inject the mixed chemical agent into the chemical agent inlet port 2 through the first pipe L1 using the chemical agent injector 30.

Next, the control circuitry 50 transmits a signal for starting the measurement of the iron ion concentration to the analyzer 40 (step S17). Then, the control circuitry 50 determines whether or not the iron ion concentration received from the analyzer 40 is within the set value range (step S18). In step S18, the set value of the iron ion concentration can be determined in accordance with the results obtained by previously investigating the cleaning target portion C. In step S18, the set value of the iron ion concentration can be, for example, 10 ppm or more. When the iron ion concentration is equal to or more than the set value, the control circuitry 50 predicts that the uppermost surface component of the scale contains iron oxide as a main component (initial layer X1).

When determining that the iron ion concentration received from the analyzer 40 is equal to or more than the set value (step S18: Yes), the control circuitry 50 closes the valve V1b, stops the chemical agent injection pump P2, opens the valve V2, and operates the water feed pump P3 (step S20). Thus, the cleaning system 1 can clean the mixed chemical agent remaining in the second pipe L2 before switching the chemical agent supplied by the chemical agent injector 30 to another chemical agent.

When determining that the iron ion concentration received from the analyzer 40 is less than the set value (step S18: No), the control circuitry 50 causes the timer to measure the elapsed time. When determining that one hour has passed (step S19: Yes), the control circuitry 50 transmits again a signal for starting the measurement of the iron ion concentration to the analyzer 40 (step S17). Then, the control circuitry 50 proceeds to step S18, and repeatedly performs step S17, step S18, and step S19 until the control circuitry 50 determines that the iron ion concentration received from the analyzer 40 is equal to or more than the set value.

After performing step S20, the control circuitry 50 opens only the valve V1c among the valves V1a, V1b, and V1c to operate the chemical agent injection pump P2 (step S21). The water feed pump P3 is in a stopped state, and the valves V1a, V1b, and V2 are in a closed state. Thus, the control circuitry 50 can inject the acidic chemical agent into the chemical agent inlet port 2 through the first pipe L1 using the chemical agent injector 30.

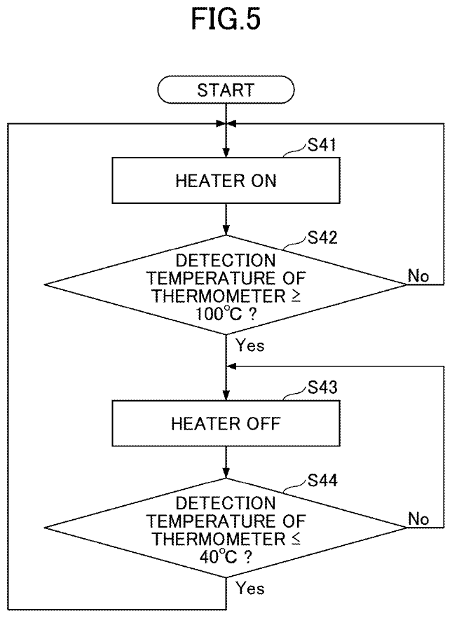

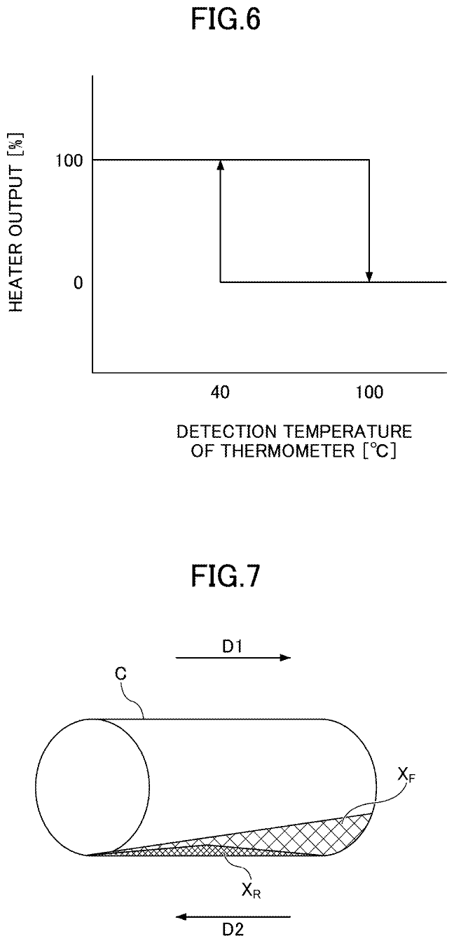

FIG. 5 is a diagram illustrating a flow of temperature control performed by the control circuitry 50. FIG. 6 is a graph illustrating a relationship between the detection temperature of the thermometer and the output of the heater. The control circuitry 50 may further control the heater 4 such that the detection temperature of the thermometer 5 is 40 °C or higher and 100 °C or lower. As illustrated in FIG. 5, the control circuitry 50 turns on the output of the heater 4 (step S41), and determines whether or not the detection temperature of the thermometer 5 is equal to or higher than 100 °C (step S42). In step S42, the set value of the detection temperature of the thermometer 5, serving as a threshold, is not limited to being equal to or higher than 100 °C, and may be any temperature.

When determining that the detection temperature received from the thermometer 5 is equal to or higher than 100 °C (step S42: Yes), the control circuitry 50 turns off the output of the heater 4 (step S43). When determining that the detection temperature received from the thermometer 5 is not equal to or higher than 100 °C (step S42: No), the control circuitry 50 returns to step S41, and repeatedly performs steps S41 and S42 until the control circuitry 50 determines that the detection temperature received from the thermometer 5 is equal to or higher than 100 °C.

After performing step S43, the control circuitry 50 determines whether or not the detection temperature of the thermometer 5 is equal to or lower than 40 °C (step S44), In step S44, the set value of the detection temperature of the thermometer 5, serving as a threshold, is not limited to being equal to or lower than 40 °C, and may be any temperature.

When determining that the detection temperature received from the thermometer 5 is equal to or lower than 40 °C (step S44: Yes), the control circuitry 50 turns on the output of the heater 4 again (step S41). When determining that the detection temperature received from the thermometer 5 is not equal to or lower than 40 °C (step S44: No), the control circuitry 50 returns to step S43, and repeatedly performs steps S43 and S44 until the control circuitry 50 determines that the detection temperature received from the thermometer 5 is equal to or lower than 40 °C. That is, as illustrated in FIG. 6, the control circuitry 50 performs ON-OFF control of the heater 4.

The control circuitry 50 continues the above process until the operation of the cleaning system 1 is stopped, and ends the process when the operation of the cleaning system 1 is stopped.

Next, a configuration for reverse direction cleaning will be described. As illustrated in FIG. 2, the cleaning system 1 may further include: a third pipe L3 branched from a branch portion 7 of the chemical liquid supply pipe LS and connected to the branch portion 10 of the return pipe LR; and a fourth pipe L4 branched from a branch portion 8 on a downstream side of the branch portion 7 of the chemical liquid supply pipe LS and connected to a branch portion 11 on a downstream side of the branch portion 10 of the return pipe LR.

The cleaning system 1 may further include: a valve V4 provided in the chemical liquid supply pipe LS between the branch portion 7 and the branch portion 8; a valve V5 provided in the return pipe LR between the branch portion 10 and the branch portion 11; a valve V6 provided partway along the third pipe L3; and a valve V7 provided partway along the fourth pipe L4.

The third pipe L3, the fourth pipe L4, the valve V4, the valve V5, the valve V6, and the valve V7 are configured to circulate the chemical agent in the cleaning target portion C in a reverse direction D2. A reverse cleaning line is formed by: the third pipe L3; the return pipe LR between the branch portion 10 and the other end of the cleaning target portion C; the chemical liquid supply pipe LS between one end of the cleaning target portion and the branch portion 8; the fourth pipe L4; and a portion from the branch portion 11 to the chemical agent recovery port 3 of the return pipe LR.

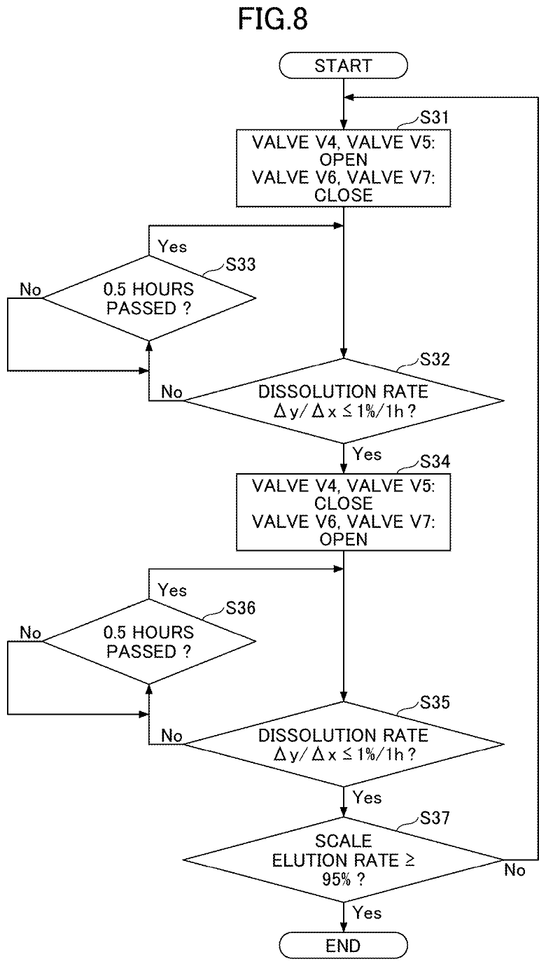

FIG. 7 is a schematic diagram for explaining the reverse direction cleaning. FIG. 8 is a diagram illustrating a flow of cleaning direction switching control performed by the control circuitry 50. When the cleaning target portion C is cleaned using the circulation line, the chemical agent is circulated in the cleaning target portion C in the forward direction D1. Thus, as illustrated in FIG. 7, scale Xr may remain on a downstream side of the forward direction D1. Therefore, after circulating the chemical agent in the cleaning target portion C in the forward direction D1, the cleaning system 1 can use the reverse cleaning line to circulate the chemical agent in the reverse direction D2, thereby removing the scale XF. Also, by circulating the chemical agent in the reverse direction D2, scale XR may remain on an upstream side of the forward direction D1. In this case, the cleaning system 1 can use the circulation line again to circulate the chemical agent in the cleaning target portion C in the forward direction D1, thereby removing the scale XR.

As illustrated in FIG. 8, the control circuitry 50 transmits a valve opening signal to the valves V4 and V5 (step S31). At this time, the valves V6 and V7 are in a closed state. Thus, the cleaning system 1 can use the circulation line to circulate the chemical agent in the cleaning target portion C in the forward direction D1. The control circuitry 50 calculates a dissolution rate of the scale based on an analysis result of the analyzer 40, and determines whether or not the dissolution rate (Δy/Δx) is equal to or less than the set value (step S32). In step S32, the set value of the dissolution rate (Δy/Δx) can be, for example, 1%/h.

When determining that the dissolution rate (Δy/Δx) is equal to or less than the set value (step S32: Yes), the control circuitry 50 transmits a signal for closing the valves V4 and V5, and transmits a signal for opening the valves V6 and V7 (step S34). Thus, the cleaning system 1 can use the reverse cleaning line to circulate the chemical agent in the cleaning target portion C in the reverse direction D2.

When determining that the dissolution rate (Δy/Δx) is not equal to or less than the set value (step S32: No), the control circuitry 50 causes the timer to measure the elapsed time. When determining that 0.5 hours has passed (step S33: Yes), the control circuitry 50 performs step S32 again, and repeatedly performs steps S32 and S33 until the control circuitry 50 determines that the dissolution rate (Δy/Δx) is equal to or less than the set value.

After performing step S34, the control circuitry 50 calculates the dissolution rate of the scale based on an analysis result of the analyzer 40, and determines whether or not the dissolution rate (Δy/Δx) is equal to or less than the set value (step S35). In step S35, the set value of the dissolution rate (Δy/Δx) can be, for example, 1%/h.

When determining that the dissolution rate (Δy/Δx) is equal to or less than the set value (step S35: Yes), the control circuitry 50 calculates a scale elution rate based on an analysis result of the analyzer 40, and determines whether or not the scale elution rate is equal to or higher than the set value (step S37). In step S37, the set value of the scale elution rate can be, for example, 95%. When determining that the scale elution rate is equal to or higher than the set value (step S37; Yes), the control circuitry 50 ends the process, i.e., determines that cleaning is completed.

When determining that the dissolution rate (Δy/Δx) is not equal to or less than the set value (step S35: No), the control circuitry 50 causes the timer to measure the elapsed time. When determining that 0.5 hours has passed (step S36: Yes), the control circuitry 50 performs step S35 again, and repeatedly performs steps S35 and S36 until the control circuitry 50 determines that the dissolution rate (Δy/Δx) is equal to or less than the set value.

When determining in step S37 that the scale elution rate is less than the set value (step S37: No), the control circuitry 50 performs step S31, and then performs steps S31 to S37 again.

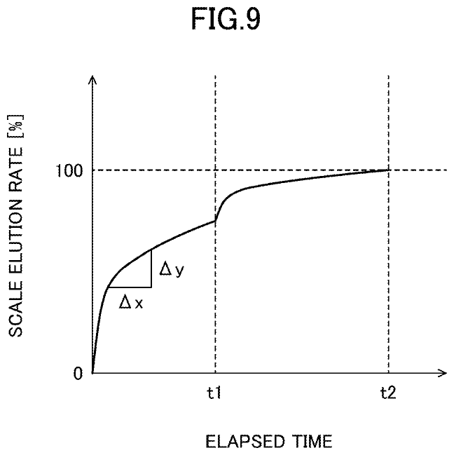

Next, calculation methods of the dissolution rate of the scale and the scale elution rate will be described. FIG. 9 is a graph illustrating a relationship between the elapsed time and the scale elution rate. The elapsed time shown in FIG. 9 means an elapsed time from the start of cleaning. The analyzer 40 calculates an elution amount of the scale according to the following equation (1). Here, a scale main component concentration is, for example, a silica concentration. The analyzer 40 recovers the waste liquid sent to the branch pipe LB, and can measure the silica concentration, for example, by a molybdenum yellow method.

Elution amount of the scale=Scale main component concentration×Volume of the cleaning target portion C (1)

The analyzer 40 calculates an estimated amount of the scale according to the following equation (2). Here, the estimated amount of the scale means an amount of scale estimated to be deposited on the cleaning target portion C. The estimated amount of the scale can be previously set by conducting a preliminary investigation of the cleaning target portion C. The estimated amount of the scale is not limited to an amount obtained according to the following equation (2), and may be calculated by any other calculation formula or method.

Estimated amount of the scale=Area of the inner surface of the cleaning target portion C×Estimated thickness of the scale×Density of the scale (2)

The analyzer 40 calculates the scale elution rate according to the following equation (3) based on the calculated estimated amount of the scale and the calculated elution amount of the scale.

Scale elution rate [%]=Elution amount of the scale/Estimated amount of the scale×100 (3)

The analyzer 40 calculates the scale elution rate relative to the elapsed time, and can obtain data as shown in FIG. 9. In FIG. 9, a time t1 is the time at which step S34, i.e., the reverse direction cleaning, is started, and a time t2 is the time at which the process shown in FIG. 8 is ended.

The analyzer 40 calculates the dissolution rate of the scale according to the following equation (4) based on the calculated scale elution rate.

Dissolution rate of the scale=Δy (change in the scale elution rate)/Δx (change in the elapsed time) (4)

As described above, the cleaning system 1 includes the chemical liquid supply pipe LS, the chemical agent injector 30, the first pipe L1, the return pipe LR, the circulation pump P1, the analyzer 40, and the control circuitry 50. The control circuitry 50 predicts the uppermost surface component of the scale based on the analysis result of the analyzer 40, determines one chemical agent suitable for the uppermost surface component from among at least three chemical agents, and controls the chemical agent injector 30 to supply the determined chemical agent.

With this configuration, the cleaning system 1 can clean the scale adhering to or deposited on the cleaning target portion C using a chemical agent that is optimal for the uppermost surface component of the scale. Therefore, the cleaning system 1 can sufficiently remove the scale.

The three chemical agents can be: the first basic chemical; the mixed chemical agent of the second basic chemical agent, the chelating agent, and the dispersant; and the acidic chemical agent. With this configuration, the cleaning system 1 can use chemical agents that are respectively optimal for the initial layer X1 containing iron oxide as a main component, the intermediate layer X2 containing, as main components, silica and impurities (calcium, aluminum, iron, etc.), and the growth layer X3 containing amorphous silica as a main component, which respectively form the scale. Therefore, the cleaning system 1 can sufficiently remove the scale.

The control circuitry 50 can predict the uppermost surface component of the scale based on the iron ion concentration detected by the analyzer 40. With this configuration, the cleaning system 1 can predict the uppermost surface component of the scale in a closed system without releasing or disassembling the geothermal power generation plant, determine one chemical agent suitable for the uppermost surface component from among at least three chemical agents, and supply the determined chemical agent using the chemical agent injector 30. Therefore, the cleaning system 1 can remove the scale in a simple manner.

The cleaning system 1 includes the heater 4 and the thermometer 5, and the control circuitry 50 can control the heater 4 based on the detection temperature of the thermometer 5. With this configuration, the cleaning system 1 can supply the heated chemical agent to the cleaning target portion C, thereby enhancing the cleaning effect of the chemical agent.

The control circuitry 50 can control the heater 4 such that the detection temperature of the thermometer 5 is 40 °C or higher and 100 °C or lower, Thus, the cleaning system 1 can supply, to the cleaning target portion C, the chemical agent heated to be in a temperature range in which the cleaning effects of the first basic chemical agent, the mixed chemical agent, and the acidic chemical agent are enhanced, thereby further enhancing the cleaning effect of the chemical agent.

The first basic chemical agent and the second basic chemical agent can be sodium hydroxide, potassium hydroxide, or ammonium salts. Thus, the cleaning system 1 can clean the growth layer X3 and the intermediate layer X2 of the scale using more optimal chemical agents.

The acidic chemical agent can be sulfuric acid, hydrochloric acid, acetic acid, or citric acid. Thus, the cleaning system 1 can clean the initial layer X1 of the scale using a more optimal chemical agent.

The chelating agent included in the mixed chemical agent can be ethylenediaminetetraacetic acid, nitrilotriacetic acid, hydroxyethylenediaminetriacetic acid, or diethylenetriaminepentaacetic acid. Thus, the cleaning system 1 can clean the intermediate layer X2 of the scale using a more optimal chemical agent.

The dispersant included in the mixed chemical agent can be sodium polyacrylate, maleic acid, or a diallyldimethylammonium chloride-acrylamide copolymer. Thus, the cleaning system 1 can clean the intermediate layer X2 of the scale using a more optimal chemical agent.

The chemical agent injector 30 can include: the three chemical agent tanks 31a, 31b, and 31c; the second pipe L2; the chemical agent injection pump P2; the water tank 32; the water feed pump P3; the water drain pipe LW; and the waste water tank 33. With this configuration, the cleaning system 1 can wash away the chemical agent remaining, before switching, in the second pipe L2 when switching the type of the chemical agent to be supplied using the chemical agent injector 30. Therefore, the cleaning system 1 can suppress a reduction in the cleaning effect of the chemical agent determined by the control circuitry 50 due to mixing with another chemical agent.

The geothermal power generation plant 100 includes: the gas-liquid separator 103 configured to separate geothermal brine and geothermal steam from geothermal fluid emitted from the production well; the cleaning target portion C provided on the downstream side of the gas-liquid separator 103; and the cleaning system 1. With this configuration, the geothermal power generation plant 100 can clean the scale adhering to or deposited on the cleaning target portion C using a chemical agent that is optimal for the uppermost surface component of the scale. Therefore, the geothermal power generation plant 100 can sufficiently remove the scale.

According to the geothermal power generation system according to the aspect of the present disclosure, it is possible to sufficiently remove the scale of a re-injection line.

Although the embodiments have been described above, the above-described embodiments are presented as examples, and the present disclosure is not limited by the above-described embodiments. The cleaning system 1 is not limited to the geothermal power generation plant 100, and is applicable to any geothermal power generation plant. The above-described embodiments can be implemented in various other forms, and various combinations, omissions, substitutions, modifications, or the like can be made without departing from the intent of the invention. The above-described embodiments and variations thereof are included in the scope or intent of the invention, and are included in the scope of equivalents to the inventions recited in the claims,

The above-disclosed embodiments are specified, for example, by the following embodiments.

[1] A cleaning system configured to remove scale adhering to a cleaning target portion in a geothermal power generation plant including a gas-liquid separator configured to separate geothermal brine and geothermal steam from geothermal fluid emitted from a production well, and the cleaning target portion provided on a downstream side of the gas-liquid separator, the cleaning system including:
a chemical liquid supply pipe that is connectable to one end on an upstream side of the cleaning target portion, and includes a chemical agent inlet port;
a chemical agent injector that is configured to inject a chemical agent into the chemical agent inlet port;
a first pipe that connects the chemical agent inlet port and the chemical agent injector, and includes a chemical agent recovery port;
a return pipe that connects another end on a downstream side of the cleaning target portion and the chemical agent recovery port;
a circulation pump that is provided partway along the first pipe between the chemical agent inlet port and the chemical agent recovery port, and is configured to circulate the chemical agent;
an analyzer that is connected to a branch pipe branched from the first pipe, and is configured to analyze change over time in components of waste liquid sent to the branch pipe; and
control circuitry, wherein
the control circuitry is configured to predict an uppermost surface component of the scale based on an analysis result of the analyzer, determine one chemical agent suitable for the uppermost surface component from among at least three chemical agents, and control the chemical agent injector to supply the determined chemical agent.

[2] The cleaning system according to [1], wherein
the three chemical agents are:
   a first basic chemical agent;
   a mixed chemical agent of a second basic chemical agent, a chelating agent, and a dispersant; and
   an acidic chemical agent.

[3] The cleaning system according to [1] or [2], wherein
the control circuitry is further configured to predict the uppermost surface component of the scale based on an iron ion concentration detected by the analyzer.

[4] The cleaning system according to any one of [1] to [3], further including:
a heater that is provided partway along the first pipe between the circulation pump and the chemical agent inlet port; and
a thermometer that is connected to the first pipe between the heater and the chemical agent inlet port, wherein
the control circuitry is further configured to control the heater based on a detection temperature of the thermometer.

[5] The cleaning system according to [4], wherein
the control circuitry is further configured to control the heater such that the detection temperature of the thermometer is 40 °C or higher and 100 °C or lower.

[6] The cleaning system according to [2], wherein
the first basic chemical agent and the second basic chemical agent include sodium hydroxide, potassium hydroxide, or ammonium salts.

[7] The cleaning system according to [2], wherein
the acidic chemical agent includes sulfuric acid, hydrochloric acid, acetic acid, or citric acid,

[8] The cleaning system according to [2], wherein
the chelating agent included in the mixed chemical agent includes ethylenediaminetetraacetic acid, nitrilotriacetic acid, hydroxyethylenediaminetriacetic acid, or diethylenetriaminepentaacetic acid.

[9] The cleaning system according to [2], wherein
the dispersant included in the mixed chemical agent includes sodium polyacrylate, maleic acid, or a diallyldimethylammonium chloride-acrylamide copolymer.

[10] The cleaning system according to any one of [1] to [9], wherein
the chemical agent injector includes:
   at least three chemical agent tanks that are configured to store the chemical agent;
   a second pipe that connects the first pipe and each of the chemical agent tanks;
   a chemical agent injection pump that is configured to discharge the chemical agent stored in each of the chemical agent tanks toward the chemical agent inlet port;
   a water tank that is disposed on an upstream side of the chemical agent tanks, and is configured to store water;
   a water feed pump that is configured to introduce the water into the second pipe;
   a water drain pipe that is branched from the second pipe on a downstream side of the chemical agent injection pump; and
   a waste water tank that is connected to the water drain pipe, and is configured to store the water passed through the second pipe.

1. A cleaning system configured to remove scale adhering to a cleaning target portion in a geothermal power generation plant including a gas-liquid separator configured to separate geothermal brine and geothermal steam from geothermal fluid emitted from a production well, and the cleaning target portion provided on a downstream side of the gas-liquid separator, the cleaning system comprising;
a chemical liquid supply pipe that is connectable to one end on an upstream side of the cleaning target portion, and includes a chemical agent inlet port;
a chemical agent injector that is configured to inject a chemical agent into the chemical agent inlet port;
a first pipe that connects the chemical agent inlet port and the chemical agent injector, and includes a chemical agent recovery port;
a return pipe that connects another end on a downstream side of the cleaning target portion and the chemical agent recovery port;
a circulation pump that is provided partway along the first pipe between the chemical agent inlet port and the chemical agent recovery port, and is configured to circulate the chemical agent;
an analyzer that is connected to a branch pipe branched from the first pipe, and is configured to analyze change over time in components of waste liquid sent to the branch pipe; and
control circuitry, wherein
the control circuitry is configured to predict an uppermost surface component of the scale based on an analysis result of the analyzer, determine one chemical agent suitable for the uppermost surface component from among at least three chemical agents, and control the chemical agent injector to supply the determined chemical agent.

2. The cleaning system according to claim 1, wherein
the three chemical agents are:
a first basic chemical agent;
a mixed chemical agent of a second basic chemical agent, a chelating agent, and a dispersant; and
an acidic chemical agent.

3. The cleaning system according to claim 2, wherein
the control circuitry is further configured to predict the uppermost surface component of the scale based on an iron ion concentration detected by the analyzer.

4. The cleaning system according to claim 3, further comprising:
a heater that is provided partway along the first pipe between the circulation pump and the chemical agent inlet port; and
a thermometer that is connected to the first pipe between the heater and the chemical agent inlet port, wherein
the control circuitry is further configured to control the heater based on a detection temperature of the thermometer.

5. The cleaning system according to claim 4, wherein
the control circuitry is further configured to control the heater such that the detection temperature of the thermometer is 40 °C or higher and 100 °C or lower.

6. The cleaning system according to claim 2, wherein
the first basic chemical agent and the second basic chemical agent include sodium hydroxide, potassium hydroxide, or ammonium salts.

7. The cleaning system according to claim 2, wherein
the acidic chemical agent includes sulfuric acid, hydrochloric acid, acetic acid, or citric acid.

8. The cleaning system according to claim 2, wherein
the chelating agent included in the mixed chemical agent includes ethylenediaminetetraacetic acid, nitrilotriacetic acid, hydroxyethylenediaminetriacetic acid, or diethylenetriaminepentaacetic acid.

9. The cleaning system according to claim 2, wherein
the dispersant included in the mixed chemical agent includes sodium polyacrylate, maleic acid, or a diallyldimethylammonium chloride-acrylamide copolymer.

10. The cleaning system according to claim 1, wherein
the chemical agent injector includes:
at least three chemical agent tanks that are configured to store the chemical agent;
a second pipe that connects the first pipe and each of the chemical agent tanks;
a chemical agent injection pump that is configured to discharge the chemical agent stored in each of the chemical agent tanks toward the chemical agent inlet port;
a water tank that is disposed on an upstream side of the chemical agent tanks, and is configured to store water;
a water feed pump that is configured to introduce the water into the second pipe;
a water drain pipe that is branched from the second pipe on a downstream side of the chemical agent injection pump; and
a waste water tank that is connected to the water drain pipe, and is configured to store the water passed through the second pipe.
